(19) United States
(12) Patent Application Publication
(10) Pub. No.: US 2006/0026089 A1
(43) Pub. Date: Feb. 2, 2006

(54) Telephonic device to connect query initiator to provider

(75) Inventors: Sebastian Replanski, Belleair Beach, FL (US); Carmin Turco, New York, NY (US)

Correspondence Address: PITNEY HARDIN LLP, 7 TIMES SQUARE, NEW YORK, NY, 10036-7311, US

(73) Assignee: WeBe Yellow, Inc.

(21) Appl. No.: 11/190,603

(22) Filed: Jul. 27, 2005

Related U.S. Application Data
(60) Provisional application No. 60/591,980, filed on Jul. 29, 2004.

(51) Int. Cl. G06Q 40/00

(52) U.S. Cl. 705/37

(57) ABSTRACT

The present disclosure pertains to a method and an apparatus for facilitating communication between a potential customer and a potential provider of goods and services, and further provides a method for the financing of the method and apparatus. This method and apparatus are particularly applicable to expensive and/or personalized services where a traditional website does not communicate the quality of the services well or establish the trust needed for such a relationship while retaining the applicability to small or non-personalized purchases. This method and apparatus is likewise applicable to services which can be provided only within a certain distance from the provider. The potential customer uses the internet or other devices to enter a request for goods or services. This information is used to generate an audio file and telephone the potential provider to determine if the potential provider would like to have an initially anonymous telephone call with the potential customer. If the potential provider agrees, the telephone call is bridged or otherwise arranged, and the potential provider is charged for this service.

This application claims priority of provisional application Ser. No. 60/591,980, filed on Jul. 28, 2004.

### BACKGROUND OF THE INVENTION

1. Field of the Invention

The present invention pertains to a method and apparatus for establishing telephonic communication between a web searcher, typically searching for a product or service, and a provider of the product or service. This method and apparatus can be likewise adapted for web searchers seeking personal associations, such as dating or matchmaking, rather than commercial goods or services.

2. Description of the Prior Art

The internet has revolutionized commerce within the world. This has allowed commerce, particularly commerce involving staple consumer items such as books, electronic apparatus, audiovisual media, etc. to be sold over the internet with virtually no concern regarding the geographic proximity of the customer and seller. Similarly, sales of items with otherwise limited supply and demand within a small geographic area, such as antiques or used books, have increased dramatically with the opening of markets over the internet. Similarly, auctions of both staple consumer items and unique items have allowed customers and sellers to conduct commerce world-wide.

However, perhaps as much as eighty-five percent of the commerce on the internet is facilitated by search engines, with the dominant financing thereof being based on “pay per click”. The dramatic opening of markets as described above is powerful testimony to the effectiveness of this business method and model. However, this business method and model have deficiencies in some aspects. Firstly, the “pay-per-click” aspect allows the introduction of click fraud. Typical instances of click fraud occur when a web host places a merchant's advertisement on the web host's website. The website keeps track of the number of times the website is accessed (i.e., the number of “clicks”) by users and the merchant pays the web host in accordance with this number. Therefore, the web host has an incentive to access the advertisements on his or her own site in order to increase the number of “clicks”, thereby increasing the fee paid by the merchant with no value delivered to the merchant. Automated “bots” have been written to facilitate such click fraud. Likewise, a competitor of the merchant may repeatedly access the advertisement on the website in order to increase the web advertising fees paid by the merchant, again with no benefit accruing to the merchant.

Additionally, while internet commerce fueled by traditional search engines, including payment for search engine placement, and the “pay-per-click” model is highly effective for straightforward transactions involving mass produced products, it is less effective for the marketing of sophisticated services, particularly local services where eventual face-to-face contact is required, such as interior design, financial planning, home repair and business accounting. Similarly, sophisticated services require a level of trust to be established. Such a level of trust is unlikely to be satisfactorily established by even the most elegant website. Such a level of trust is still most likely to be established by personal conversations between the potential customer and sales staff.

Prior internet methods have been deficient in finding ways to make the introductions required for such sophisticated services, and in finding ways to finance such a business method and model.

Moreover, many traditional businesses are now realizing that the value of their business is more than the value of their buildings and their inventory. Rather, the value of their businesses is based upon the quality of their customer bases. Many traditional businesses are trying to find ways to attract good profitable customers and avoid customers who do such things as return products not in saleable condition, return products after claiming a rebate, demand lower prices, and take up too much time of the sales staff without making purchases. Unfortunately, in many instances, the internet has provided such undesirable customers with the information necessary to engage in such practices that are unprofitable to the business. Prior internet methods have been very deficient in allowing vendors to pick and choose among potential customers in order to develop a base of good profitable customers while avoiding undesirable customers who engage in predatory practices.

The prior art includes U.S. Pat. No. 6,636,590 entitled “Apparatus and Method for Specifying and Obtaining Services Through Voice Commands”, issued on Oct. 21, 2003 to Jacob et al. With this method, a service seeker can use the internet to select, contact converse and pay for a service provider, such as a psychiatrist. This requires the service seeker to select the provider and to initiate the communication.

Similarly, U.S. Patent Publication No. 2002/0169626 entitled “Method and Apparatus for Providing a Reference” allows a customer to choose a merchant or service provider based upon data in a database, which may include information from prior customers. Subsequent communication between the merchant and the customer may be performed by various methods, including the telephone.

U.S. Pat. No. 6,223,165 entitled “Method and Apparatus to Connect Consumer to Expert” issued on Apr. 24, 2001 to Lauffer, including progeny thereof, relates to a web search wherein the names and characteristics of experts who are available to give advice are displayed to the consumer and the consumer chooses from the list whereupon a telephone call between the consumer and the expert is initiated, the consumer is billed for the service provided, and a portion of the billing goes to the web service with the remainder going to the expert. U.S. Patent Publication No. 2003/0144895 entitled “Prepaid Personal Advisory Service for Cellular Networks” implements a similar system through a cellular telephone.

Similarly, U.S. Pat. No. 6,704,403 entitled “Apparatus and Method for Ensuring a Real-Time Connection Between Users and Selected Service Provider Using Voice Mail” issued on Mar. 9, 2004 to Lurie adds voicemail into such a system for finding a service provider and U.S. Patent Publication No. 2003/0115089 entitled “Apparatus and Method for Online Advice Customer Relationship Management”, also to Lurie, discloses a system for managing the “relationship” between a plurality of service providers and a plurality of service seekers.

U.S. Pat. No. 5,862,223 entitled “Method and Apparatus for a Cryptographically Assisted Commercial Network Designed to Facilitate and Support Expert-Based Commerce”, issued on Jan. 19, 1999 to Walker matches experts and end users and includes the experts bidding for the lowest expert fees. That is, the experts are not bidding to pay a higher amount to the matching service, but rather are bidding for the lowest fee received from the end user.

U.S. Patent Application Publication No. 2004/0153368 entitled “Systems and Methods to Facilitate Selling of Products and Services” relates to the use of session information for a consumer's website session on a provider's website, which has already been located by the consumer to match the consumer with a sales associate from the provider. The subsequent communication can be performed by various modes, including telephonically.

U.S. Patent Application Publication No. 2002/0082938 entitled “Systems, Methods and Computer Program Products That Facilitate and Account for Call-Through Advertising Between advertisers and Users of Web-Enabled Telephone Devices” relates to establishing telephonic communication between a web-enabled telephone and an advertising server in response to user activation of an advertisement displayed on the web-enabled telephone.

Other prior art includes U.S. Pat. No. 6,519,570; U.S. Pat. No. 6,192,050 and U.S. Patent Publication No. 2003/0132298.

Finally, the websites improvenet.com allows contractors to place traditional bids for the price to be received on jobs, customerzone.com allows customers to receive free multiple quotes and ingenio.com allows the customer to initiate the telephone call with the provider being charged on a per-call basis.

### OBJECTS AND SUMMARY OF THE INVENTION

It is therefore an object of the present invention to provide a business method and model for the internet to provide for introductions between a query initiator and the provider of a sophisticated, personalized and/or expensive product or service as well as small or non-personalized purchases.

It is therefore a further object of the present invention to provide a business method and model for the internet to provide for the introductions between a query initiator and the provider of a local product or service.

It is therefore a still further object of the present invention to provide a business method and model for the internet to allow direct conversation between the sales staff and a potential customer.

It is therefore a still further object of the present invention to provide a business method and model for the internet which allows a provider of products or services to pick and choose among the potential customers in order to develop a base of good clients or customers, while avoiding the less desirable clients or customers.

It is therefore a still further object of this invention to provide a business method and model for the internet which provides initial anonymity in the communication between a potential customer and a provider of goods or services.

It is therefore a final object of the present invention to provide a business method and model which achieves the above objects with a clear method for the financing thereof and which reduces the possibility of fraud in the financing.

These and other objects are attained by providing a business method and model wherein potential customers who are engaged in a web session, typically initially using convention search techniques, are brought to a website where the potential customers enter the particulars of the desired transaction. For instance, the customer would enter the type of transaction desired (interior design, accounting, etc.), how much they want to spend, their location and contact information and the time period in which they would like to make the transaction. Analogous information is entered for dating or matchmaking applications. The contact information would include a telephone number or similar information to allow contacting the potential customer.

The information entered by the potential customer is compared to a database of providers of goods and services. When a possible or plausible match is made between the information provided by a potential customer and the parameters previously entered for each provider, the provider is contacted. This is typically done by generating an audio file from the text using the information from the potential customer and telephoning the provider. The audio file telephonically conveys to the provider the information entered by the potential customer. The provider is then asked to signal (typically by pressing a button on the telephone) if the provider would like to telephonically contact the potential customer. If the provider responds affirmatively, telephone contact is made between the potential customer and the provider using the information provided by the potential customer. Typically, this is done by the apparatus initiating telephone contact with the potential customer and then bridging the telephone connection between the potential customer and the provider. This provides at least initial anonymity between the parties, so that the parties can evaluate each other. The parties can then choose to disclose contact information or they can terminate communications while maintaining anonymity.

The funding of this business method and model is provided by charging the provider whenever the provider responds affirmatively to establish initial communication with the potential customer and the communication is indeed established. Typically, if the provider declines to establish initial communication with the potential customer, then no fee is charged. Additionally, an auction can be held amongst a plurality of providers wherein the providers, based on the information given by the potential customer, bid for the contact with the potential customer.

### DESCRIPTION OF THE DRAWINGS

Further objects and advantages of the invention will become apparent from the following description and claims, and from the accompanying drawings:

FIG. 1 is a flowchart of the query entry, user call back and user recording sections of the method and apparatus of the present invention.

FIG. 2 is a flowchart of the provider matching section of the method and apparatus of the present invention.

FIG. 3 is a flowchart of the provider contact section of the method and apparatus of the present invention.

FIG. 4 is a flowchart of provider broadcast section of the method and apparatus of the present invention.

FIG. 5 is a flowchart of the user contact section of the method and apparatus of the present invention.

FIG. 6 is a flowchart of the scoring system section of the method and apparatus of the present invention.

### DETAILED DESCRIPTION OF THE PREFERRED EMBODIMENTS

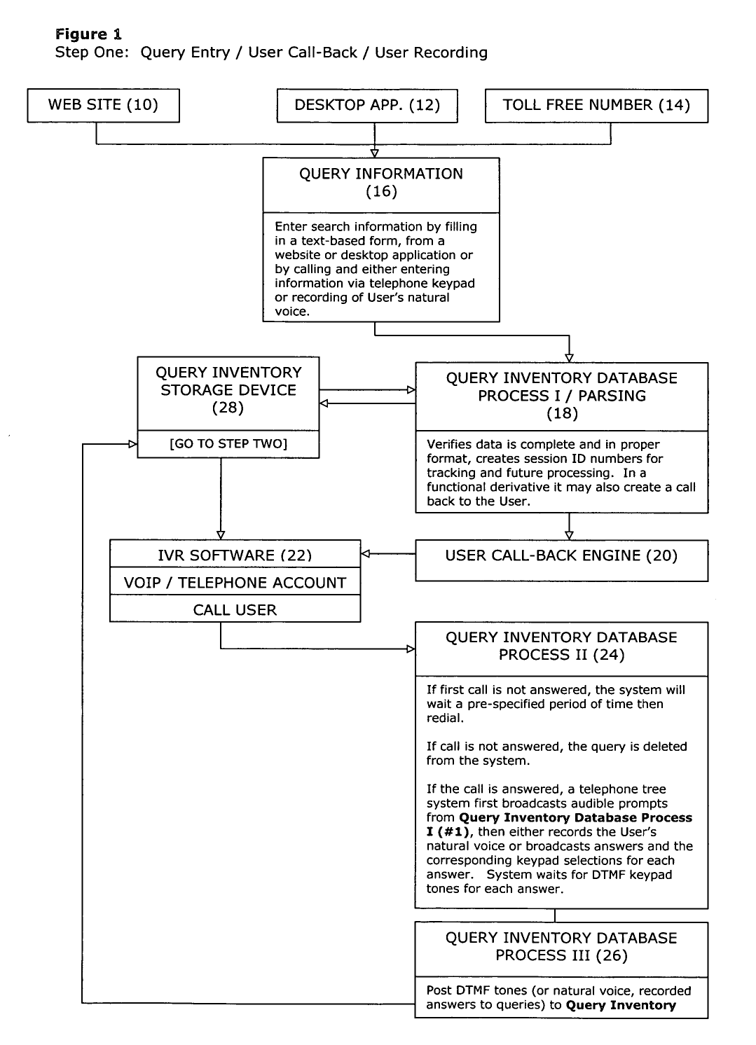

Referring now to the drawings in detail wherein like numerals indicate like elements throughout the several views, one sees that FIG. 1 is the query entry/user call-back/user recording section of the present invention.

The potential customer uses a website 10, local desktop computer connected to a network 12 or even a telephone line (preferably toll free) 14 to enter query information 16. Those skilled in the art will readily recognize the suitable query information after review of this disclosure. Typical query information would include the type of goods or services sought, the geographic location, when the goods or services are required, the price the potential customer is willing to pay, corporate information (if any, such as number of employees, credit information) and, perhaps most importantly, contact information, preferably telephonic (including VOIP) contact information. Analogous information, such as personal characteristics, requirements and goals would be entered into a dating or matchmaking site.

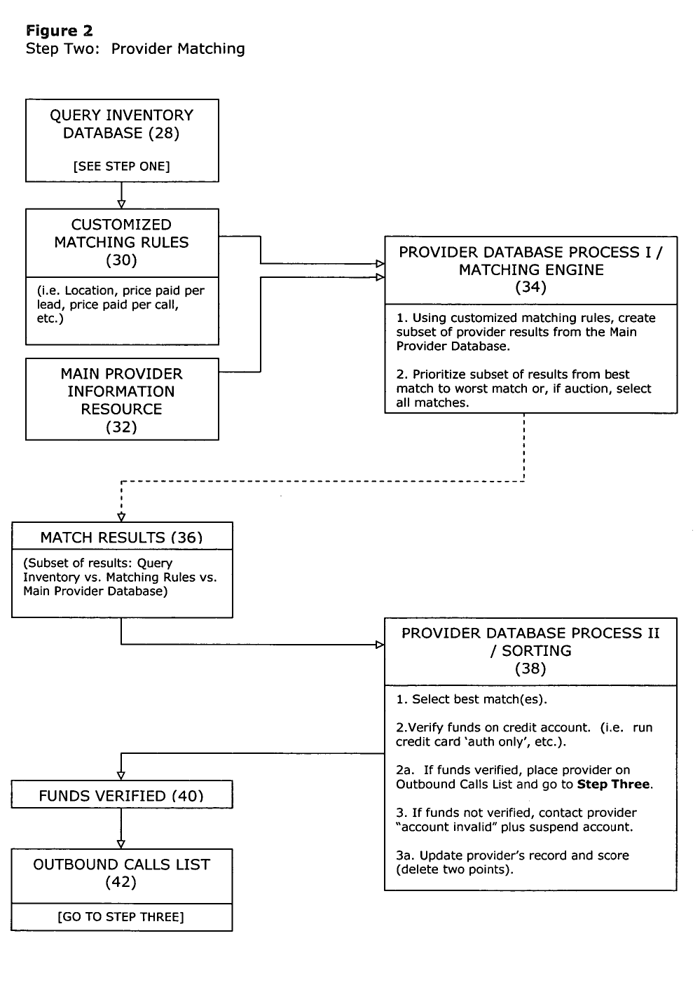

Query inventory database process I/parsing block 18 verifies the data is complete and in proper format, and creates session ID numbers for tracking and future processing. User call back engine 20 along with IVR software 22 is used to call back the potential customer to verify the contact information. Query inventory database process II block 24 re-dials the telephone number if the first telephone call is not answered, and deletes the inquiry if the telephone number from the contact information is not eventually answered. If the telephone number is answered, further information can be collected via natural language or DTMF responses to further inquiries by the query inventory database process III block 26. The data is then added to query inventory database 28. If further inquiries are necessary, the process proceeds to IVR software. Otherwise, the process proceeds to FIG. 2.

As shown in FIG. 2, the data from query inventory database 28, along with customized matching rules 30 (such as location, price paid per lead, price paid per call, etc.) and main provider database 32 (which includes data from the providers of goods and services) are input into provider database process I/matching engine 34. Provider database process I/matching engine 34 uses customized matching rules to create a subset of provider results from the main provider database 32 and to prioritize a subset of match results 36 from best match to worst match (alternatively, if an auction system is used to select the provider of goods and services, then all plausible providers of the requested goods and services are selected).

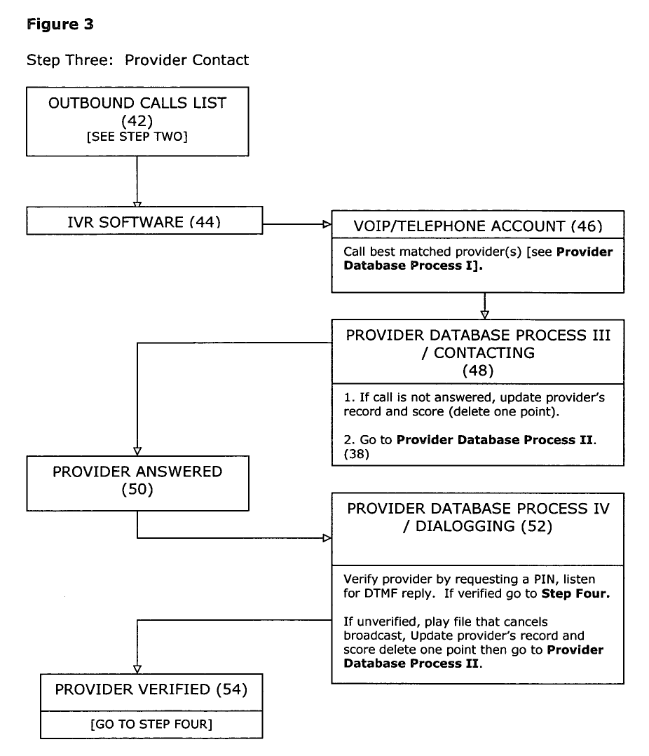

Provider database process II/sorting block 38 selects the best matches and verifies the finds or creditworthiness of the providers of goods and services to be contacted. If the funds are verified (block 40), then a list of outbound calls (block 42) is generated and the process proceeds to FIG. 3.

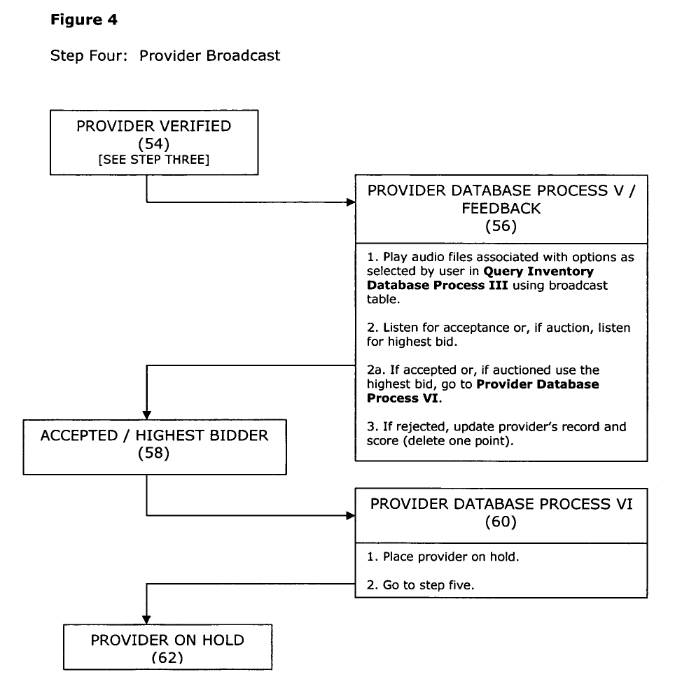

As shown in FIG. 3, after the list of outbound calls (block 42) is generated, the IVR software, typically using a VOIP/telephone account 46, in combination with the provider database process II/contacting block 48 telephones the selected provider of goods and services. If the provider does not answer, then the process returns to provider database process II/sorting block 38 to find another potential provider. Additionally, the non-answering provider may have its score or ranking decreased. If the provider does answer the telephone call (block 50), the provider is asked (typically by synthesized speech) by provider database process IV/dialoging box 52 to verify its identity (typically by entering a personal identification number by DTMF tones via the telephone keypad). If the provider is unable to verify itself, then the process returns to provider database process II/sorting block 38 to find another potential provider. Additionally, the non-verifying provider may have its score or ranking decreased. If the provider verifies itself (block 54), then the process proceeds to FIG. 4.

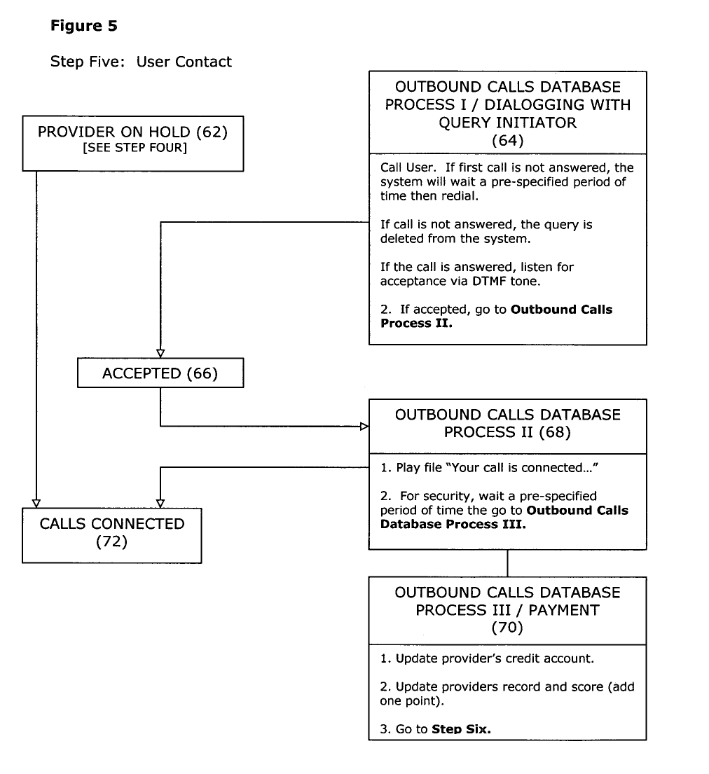

As shown in FIG. 4, after the provider verifies itself (block 54), the provider database process V/feedback block 56 plays an audio file of synthesized speech or natural voice giving the essential information (but, typically not contact or identifying information) concerning the potential customer to the potential provider. The potential provider can then accept the offer (or, in an auction environment, bid on how much it would pay to speak to this customer) or decline the offer. If the potential provider declines the offer (or, in an auction environment, if other providers are to be given the chance to bid), then the process returns to provider database process IV/dialoging block 52 to find another potential provider. Additionally, the non-accepting provider may have its score or ranking decreased. If the provider accepts or, in an auction environment, places the highest bid (block 58), then the provider database process VI block 60 places the provider on hold (block 62). In an auction environment, this may require calling the provider back. The process then proceeds to FIG. 5.

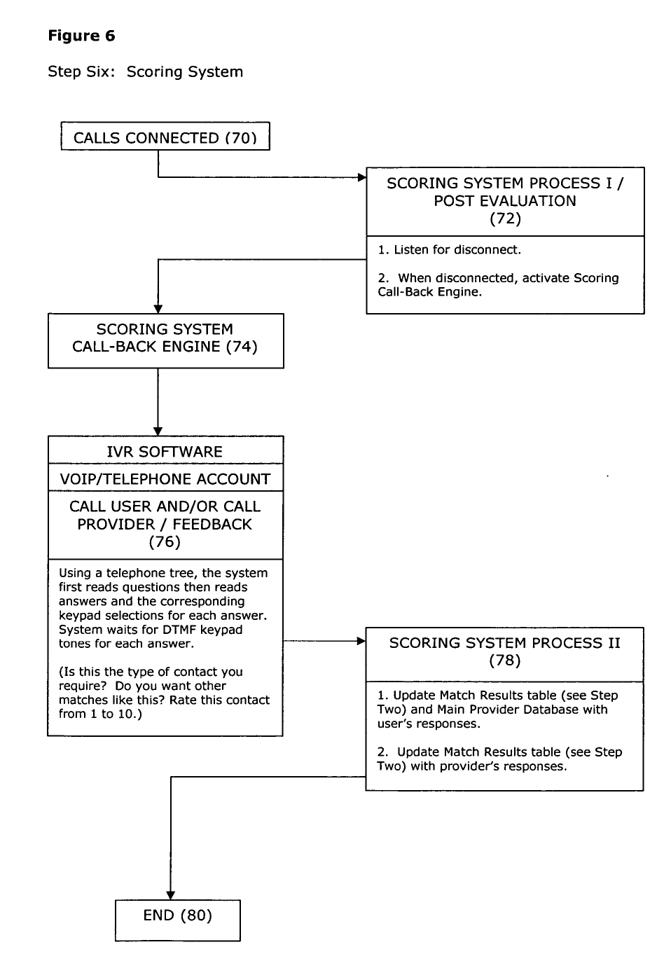

As shown in FIG. 5, with the provider on hold (block 62), outbound calls database process I/dialoging with query initiator block 64 telephones the query initiator or potential customer using the previously gathered contact information, redialing if necessary. However, if the potential customer does not answer within a certain number of attempts, the query may be deleted from the system. When the potential customer answers, the potential customer is asks to enter a DTMF tone to accept the telephone call with the potential provider. If the call is accepted (block 66), then a brief introductory message is played by outbound calls database process II block 68, the potential provider is charged for the service of providing the contact with the potential customer by outbound calls database process III/payment block 70 and the telephone calls to the potential customer and the potential provider are bridged, typically anonymously, at block 72 to discuss a possible transaction and exchange contact information. After the call between the potential customer and the potential provider is completed, the process continues to FIG. 6.

As shown in FIG. 6, after the disconnect in the telephone call between the potential customer and the potential provider is sensed by scoring process I/post evaluation block 72, the scoring system call back engine 74 is activated. Then, IVR software, typically using a VOIP or telephone account, calls the potential customer and/or the potential provider separately to query them about their satisfaction with respect to the party with whom they just finished the conversation, as shown in block 76. Responses are typically received by DTMF tones. Alternately, this query could be done by internet communication. These results are used to score the participants in scoring system process II block 78 and the process terminates as shown in block 80.

Thus the several aforementioned objects and advantages are most effectively attained. Although preferred embodiments of the invention have been disclosed and described in detail herein, it should be understood that this invention is in no sense limited thereby and its scope is to be determined by that of the appended claims.

What is claimed is:

1. A method for providing communication between a first party and a second party, including the steps of:
providing a database of potential first parties, said database including attributes of said potential first parties;
receiving inquiries from potential second parties, said inquiries includes attributes that are desired from said potential first parties;
matching said inquiries from said potential second parties with attributes of said potential first parties thereby determining at least one selected first party and at least one selected second party;
communicating with said at least one selected first party and communicating attributes that are desired by said at least one selected second party;
inquiring if said at least one selected first party desires to communicate with said at least one selected second party; and
if said at least one selected first party consents, facilitating communication between said at least one selected first party and said at least one selected second party.

2. The method of claim 1 wherein said step of facilitating communicating results in a monetary charge to said at least one selected first party.

3. The method of claim 2 wherein said potential first parties are providers of goods or services.

4. The method of claim 3 wherein said potential second parties are potential customers of at least a portion of said potential first parties.

5. The method of claim 4 wherein said step of receiving inquiries is performed over the internet or other network.

6. The method of claim 4 wherein said step of receiving inquiries is performed over a telephone line.

7. The method of claim 4 wherein said step of receiving inquiries is performed by a local computer.

8. The method of claim 5 wherein said step of communicating involves artificial speech and is performed over a telephone.

9. The method of claim 8 wherein said telephone involves VOIP.

10. The method of claim 8 wherein step of facilitating communication comprises bridging telephone calls between said at least one selected first party and said at least one selected second party.

11. The method of claim 2 wherein said step of inquiring further includes placing of a bid for said monetary charge by said at least one first party, and wherein, in said step of facilitating communication, said at least one selected first party is the highest bidding first party.

12. The method of claim 1 wherein said first and second potential parties are seeking matchmaking or dating services.

13. An apparatus for providing communication between a first party and a second party, including the steps of:
a database of potential first parties, said database including attributes of said potential first parties;
means for receiving inquiries from potential second parties, said inquiries includes attributes that are desired from said potential first parties;
means for matching said inquiries from said potential second parties with attributes of said potential first parties thereby determining at least one selected first party and at least one selected second party;
means for communicating with said at least one selected first party and communicating attributes that are desired by said at least one selected second party;
means for inquiring if said at least one selected first party desires to communicate with said at least one selected second party; and
means for facilitating communication between said at least one selected first party and said at least one selected second party, if said at least one selected first party consents.

14. The apparatus of claim 13 wherein said means for facilitating communicating results in a monetary charge to said at least one selected first party.

15. The apparatus of claim 14 wherein said potential first parties are providers of goods or services.

16. The apparatus of claim 15 wherein said potential second parties are potential customers of at least a portion of said potential first parties.

17. The apparatus of claim 16 wherein said means for receiving inquiries includes the internet or other network.

18. The apparatus of claim 16 wherein means for receiving inquiries includes a telephone line.

19. The apparatus of claim 16 wherein said means for receiving inquiries includes a local computer.

20. The apparatus of claim 17 wherein means for communicating involves artificial speech and is performed over a telephone.

21. The apparatus of claim 20 wherein said telephone involves VOIP.

22. The apparatus of claim 20 wherein means for facilitating communication bridges telephone calls between said at least one selected first party and said at least one selected second party.

23. The apparatus of claim 14 wherein means for inquiring further includes means for placing of a bid for said monetary charge by said at least one first party, and wherein, in said means for facilitating communication, said at least one selected first party is the highest bidding first party.

24. The apparatus of claim 13 wherein said first and second potential parties are seeking matchmaking or dating services.
